(19) United States
(12) Patent Application Publication
(10) Pub. No.: US 2012/0314245 A1
(43) Pub. Date: Dec. 13, 2012

(54) IMAGE PROCESSING APPARATUS, IMAGE PROCESSING SYSTEM, METHOD FOR CONTROLLING THE SAME, AND STORAGE MEDIUM THEREFOR

(75) Inventor: Kousuke Nakashima, Kawasaki-shi (JP)

(73) Assignee: CANON KABUSHIKI KAISHA, Tokyo (JP)

(21) Appl. No.: 13/124,107

(22) PCT Filed: Feb. 8, 2011
(86) PCT No.: PCT/JP11/00691

§ 371 Date: Apr. 13, 2011

(30) Foreign Application Priority Data
Feb. 26, 2010 (JP) 2010-041652

(51) Int. Cl. G06F 17/00; H04N 1/04; G06K 15/02

(52) U.S. Cl. 358/1.15; 715/273; 358/474

(57) ABSTRACT

An image processing apparatus for using an external service provided by at least one external server. The image processing apparatus includes a web browser, a reception unit, a web server unit, a display control unit, and a communication control unit. The reception unit receives service information transmitted by the at least one external server. The web server unit generates screen information for displaying an operation screen on the web browser based on the service information received by the reception unit. The display control unit displays the operation screen on the web browser based on the screen information generated by the web server unit. The communication control unit transmits and acquires image data to/from the at least one external server in response to a user instruction input via the operation screen displayed on the web browser.

### TECHNICAL FIELD

The present invention relates to an image processing apparatus capable of using an external service provided by at least one external server, an image processing system including the image processing apparatus, a method for controlling the image processing system and image processing apparatus, and a program therefor.

### BACKGROUND ART

It has been conventionally known that an image processing apparatus is connected to an external server on a network to use a service provided by the external server. For example, a technique discussed in Japanese Patent Application Laid-Open No. 2007-128370 is known, which transmits image data generated by scanning an image on a document, to a document management server on a network and register the image data in a document management database on the document management server.

Further, to enable an image processing apparatus to use an external service, the technique is known, which provides a web server function on an external server and use a web browser on the image processing apparatus as a method for connecting with the external server therefrom. In this case, the web browser of the image processing apparatus requests the external server for an operation screen. In response to the request from the image processing apparatus, an application on the external server transmits HTML data for displaying the requested operation screen. The web browser of the image processing apparatus analyzes the received HTML data and then displays the operation screen based on descriptions in the received HTML data.

However, when an image processing apparatus connects with an external server using its web browser to use the external service provided by the external server as described above, the following problems may arise. For example, when a multifunction peripheral (MFP) having a scanner function and printer function connects with an external server using its web browser, an operation screen provided by the external server may not be normally displayed. There are some possible reasons. Firstly, although operation screens provided by the external server are designed for web browsers on general-purpose personal computers (PCs), the web browser of the MFP has a smaller display area than PC web browsers in many cases, causing screen size mismatching.

Secondly, the web browser of the MFP may not conform to HTML data provided by the external server because of different browser type or different version. In this case, if the HTML data transmitted from the external server contains a description that cannot be analyzed by the web browser of the image processing apparatus, an intended operation screen cannot be displayed.

Thirdly, even if the operation screen provided by the external server can be displayed on the web browser of the MFP, the displayed operation screen is designed only for PC web browsers. Therefore, a troublesome operation is required in some cases. For example, when printing a file received from the external server, it is necessary to save the received file in a hard disk, close the web browser, select the file in the hard disk, and then instruct printing.

### CITATION LIST

### Patent Literature

PTL 1: Japanese Patent Application Laid-Open No. 2007-128370

### SUMMARY OF INVENTION

The present invention is directed to providing a mechanism for generating screen information for displaying an intended operation screen on a web browser based on service information transmitted from an external server.

According to an aspect of the present invention, an image processing apparatus having a web browser and being capable of using an external service provided by at least one external server includes: a reception unit configured to receive service information transmitted by the external server; a web server unit configured to generate screen information for displaying an operation screen on the web browser based on the service information received by the reception unit; a display control unit configured to display the operation screen on the web browser based on the screen information generated by the web server unit; and a communication control unit configured to transmit and acquire image data to/from the external server in response to a user instruction input via the operation screen displayed on the web browser.

Further features and aspects of the present invention will become apparent from the following detailed description of exemplary embodiments with reference to the attached drawings.

### BRIEF DESCRIPTION OF DRAWINGS

The accompanying drawings, which are incorporated in and constitute a part of the specification, illustrate exemplary embodiments, features, and aspects of the invention and, together with the description, serve to explain the principles of the invention.

FIG. 1 illustrates an overall configuration of an image processing system according to an exemplary embodiment of the present invention.

FIG. 2 is a block diagram illustrating a hardware configuration of a PC according to the exemplary embodiment of the present invention.

FIG. 3 is a block diagram illustrating a hardware configuration of a MFP according to the exemplary embodiment of the present invention.

FIG. 4 is a block diagram illustrating a hardware configuration of an external server according to the exemplary embodiment of the present invention.

FIG. 5 is a block diagram illustrating a software configuration of the image processing system according to the exemplary embodiment of the present invention.

FIG. 6 illustrates a transition of operation screens displayed on a web browser according to the exemplary embodiment of the present invention.

FIG. 7 is a sequence diagram illustrating processing for displaying a file list by the image processing system according to the exemplary embodiment of the present invention.

FIG. 8 is a sequence diagram illustrating scanning processing performed by the image processing system according to the exemplary embodiment of the present invention.

FIG. 9 illustrates an exemplary request message transmitted from an web application according to the exemplary embodiment of the present invention to an internal service according thereto.

FIG. 10 is a sequence diagram illustrating print processing performed by the image processing system according to the exemplary embodiment of the present invention.

FIG. 11 illustrates an exemplary response message transmitted from the web application according to the exemplary embodiment of the present invention to the web browser according thereto.

FIG. 12 is a flow chart illustrating processing performed by the web application according to the exemplary embodiment of the present invention upon reception of an initial screen acquisition request from the web browser according thereto.

FIG. 13 is a flow chart illustrating processing performed by the web application according to the exemplary embodiment of the present invention upon reception of a scanning start request from the web browser according thereto.

FIG. 14 is a flow chart illustrating processing performed by the web application according to the exemplary embodiment of the present invention upon reception of a download start request from the web browser according thereto.

### DESCRIPTION OF EMBODIMENTS

Various exemplary embodiments, features, and aspects of the invention will be described in detail below with reference to the drawings.

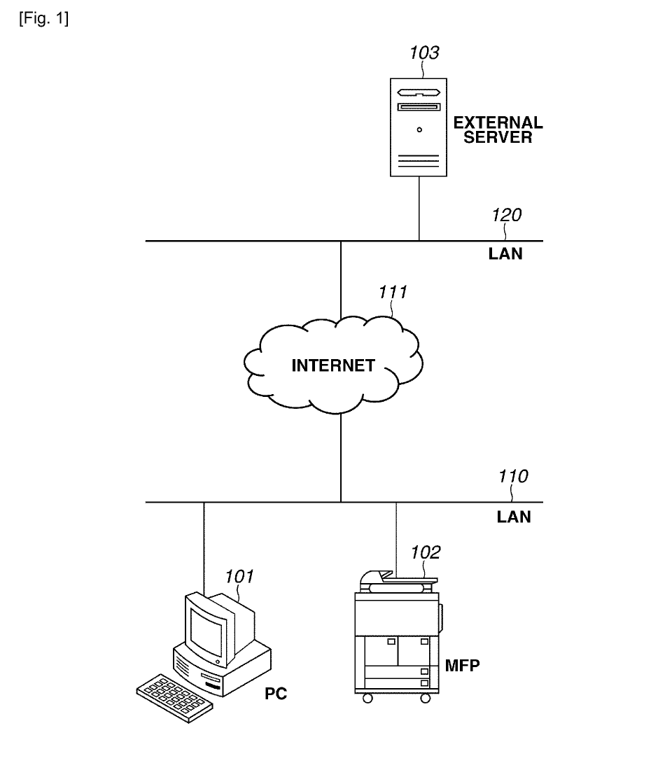

FIG. 1 illustrates an overall configuration of an image processing system according to an exemplary embodiment of the present invention. A PC 101 and an MFP 102 are connected to the Internet 111 via a LAN 110. An external server 103 providing a file management service (described below) is connected to the Internet 111 via a LAN 120. Thus, the PC 101 and the MFP 102 can communicate with the external server 103 to use the file management service provided by the external server 103.

In this example, the external server 103 solely provides the file management service. The external server 103 may be configured with a plurality of servers (server group) in which a plurality of virtual machines operates to perform distributed processing. In this case, a (cloud computing) technique called scale out is used. With the scale out, the number of virtual machines is increased depending on predetermined conditions.

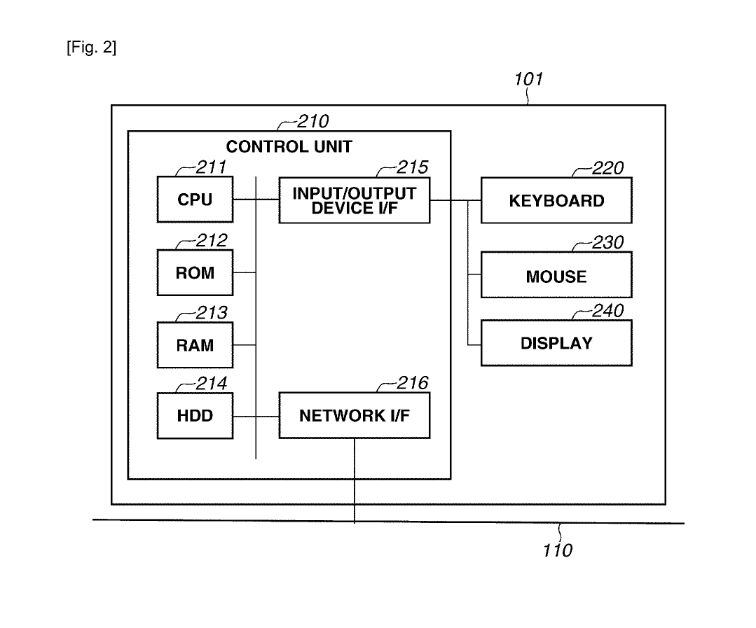

FIG. 2 is a block diagram illustrating a hardware configuration of the PC 101. A control unit 210 including a central processing unit (CPU) 211 controls the overall operation of the PC 101. The CPU 211 loads a control program stored in a read-only memory (ROM) 212 and executes various pieces of control processing. A random access memory (RAM) 213 is used as a main memory for the CPU 211 and a temporary storage area such as a work area. An HDD 214 stores image data and various programs. An input/output device interface (I/F) 215 connects a keyboard 220, a mouse 230, and a display 240 to the control unit 210.

The PC 101 is provided with a web browser function. The web browser analyzes HTML data received from a web server (for example, the external server 103) and then displays an operation screen based on HTML data descriptions on the display 240.

A network I/F 216 connects the control unit 210 (PC 101) to the LAN 110. The network I/F 216 controls data communication with the MFP 102 and the external server 103 via the LAN 110.

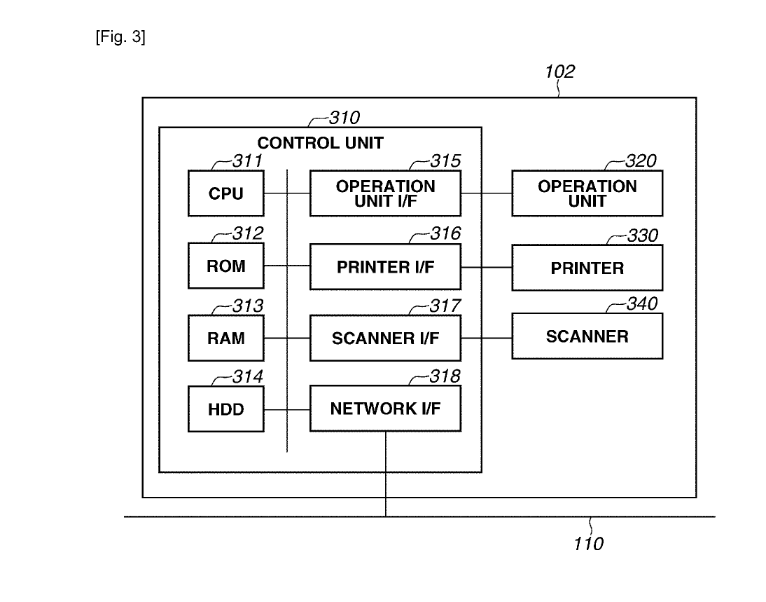

FIG. 3 is a block diagram illustrating a hardware configuration of the MFP 102. A control unit 310 including a CPU 311 controls the overall operation of the MFP 102. The CPU 311 loads a control program stored in a ROM 312 and performs various control operations such as scanning control and transmission control. A RAM 313 is used as a temporary storage area such as a main memory of the CPU 311 and a work area.

An HDD 314 stores image data and various programs. An operation unit I/F 315 connects an operation unit 320 to the control unit 310. The operation unit 320 is provided with a liquid crystal display (LCD) unit having a touch-panel function and a keyboard. The MFP 102 is provided with a web browser function and web application function. The CPU 311 analyzes HTML data received from the web application using the web browser function, and performs display control for displaying an operation screen based on HTML data descriptions on the LCD unit of the operation unit 320.

A printer I/F 316 connects a printer 330 to the control unit 310. Image data to be printed on the printer 330 is transmitted from the control unit 310 via the printer I/F 316 and then printed on a recording medium on the printer 330.

A scanner I/F 317 connects a scanner 340 to the control unit 310. The scanner 340 scans a document with an image and generates image data, and inputs the image data to the control unit 310 via the scanner I/F 317.

A network I/F 318 connects the control unit 310 of the MFP 102 to the LAN 110. The network I/F 318 performs communication control for transmitting and receiving image data and various information to/from the external server 103 via the LAN 110.

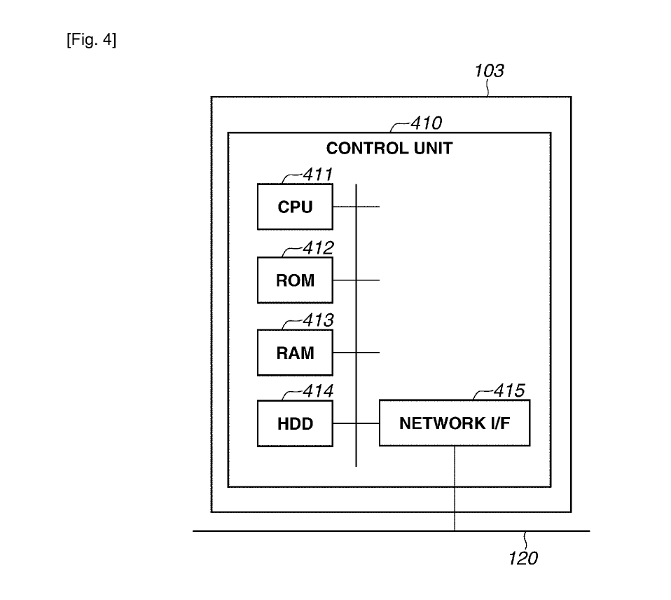

FIG. 4 is a block diagram illustrating a configuration of the external server 103. A control unit 410 including a CPU 411 controls the overall operation of the external server 103. The CPU 411 loads a control program stored in a ROM 412 and performs various control processing. A RAM 413 is used as a temporary storage area such as a main memory for the CPU 411 and a work area. An HDD 414 stores image data and various programs.

A network I/F 415 connects the control unit 410 (external server 103) to the LAN 120. The network I/F 415 controls data communication with the PC 101 and the MFP 102 via the LAN 120.

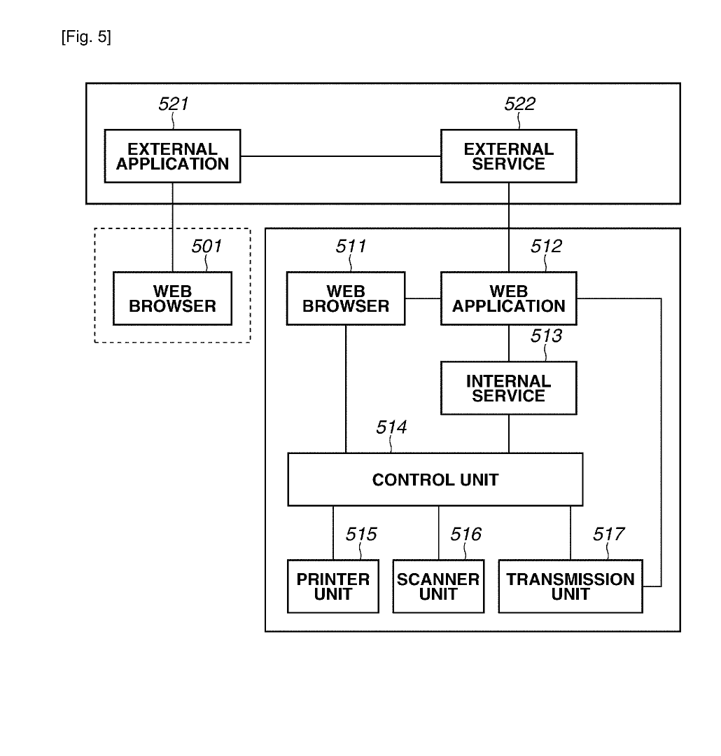

FIG. 5 is a block diagram illustrating a software configuration of the image processing system. Each function unit illustrated in FIG. 5 is implemented when each of the CPU 211 of the PC 101, the CPU 311 of the MFP 102, and the CPU 411 of the external server 103 executes a relevant control program.

The PC 101 has a web browser 501 which communicates with the external server 103 based on the HTTP protocol. More specifically, the PC 101 transmits to an external application 521 included in the external server 103 a message requesting an operation screen to be displayed on the web browser 501.

The web browser 501 receives a response message from the external application 521. The web browser 501 analyzes the response message received from the web application 512 and then displays on the display 240 an operation screen based on HTML data included in the response message.

The MFP 102 includes a web browser 511, a web application 512, an internal service 513, a control unit 514, a printer unit 515, a scanner unit 516, and a transmission unit 517.

The web browser 511 communicates with the web application 512 based on the HTTP protocol. More specifically, the web browser 511 transmits to the web application 512 a message requesting an operation screen to be displayed on the web browser 511 or a file to be printed on the printer unit 515. The web browser 511 receives a response message from the web application 512. The web browser 511 analyzes the response message received from the web application 512. The response message includes HTML data or image data. The web browser 511 analyzes the received response message, displays the operation screen on the operation unit 320, and instructs the control unit 514 to print the image data.

The web application 512 receives the request message from the web browser 511 and then transmits to the web browser 511 a response message for returning the operation screen or the file to be printed. The web application 512 transmits to the external service 522 a message requesting service provision and receives a response message from the external service 522 via the Internet 111.

The web application 512 transmits a message requesting service provision to the internal service 513. The web application 512 receives a response message from the internal service 513. Further, the web application 512 has a FTP server function, and receives image data (file) from the transmission unit 517 based on the FTP protocol.

Although the web browser 501 of the PC 101 analyzes HTML data provided by the external application 521 and can display an operation screen, the web browser 511 of the MFP 102 cannot display the same operation screen as the one displayed on the PC 101. There are some possible reasons. Firstly, a display area of the web browser 511 is smaller than a display area of the web browser 501. Secondly, the type and version of the web browser 511 do not conform to descriptions of HTML data provided by the external application 521. (The type and the version of the web browser 501 conform to descriptions of HTML data provided by the external application 521.) In this case, if HTML data provided by the external application 521 contains a description that cannot be analyzed by the web browser 511, the web browser 511 cannot display a relevant operation screen.

Therefore, in the present exemplary embodiment, the web application 512 enables displaying on the web browser 511 the operation screens related to the file management service provided by the external server 103.

Specifically, the web application 512 receives service information (information about files managed by the external server 103) from the external service 522. Then, the web application 512 having a web server function generates screen information (HTML data) for displaying an operation screen on the web browser 511 based on the received service information and then transmits it to the web browser 511. Since the screen information generated by the web application 512 can be analyzed by the web browser 511, the web browser 511 that received this screen information can display the operation screen.

The internal service 513 receives from the web application 512 a message requesting service provision. The internal service 513 analyzes the received request message and then instructs the control unit 514 to generate a job for performing specified processing. The internal service 513 also receives from the control unit 514 a notification of an execution status of the generated job. The internal service 513 generates a response message for returning the notified job execution status and then transmits it to the web application 512.

Upon reception of the instruction from the web browser 511 or the internal service 513, the control unit 514 generates a job for performing specified processing. More specifically, the control unit 514 generates a print job based on image data and a print setting specified by the web browser 511. The control unit 514 also generates a scanning/transmission job based on a scanning/transmission setting specified by the internal service 513. The control unit 514 processes the print job to generate image data and then transmits it to the printer unit 515. The control unit 514 also processes the scanning/transmission job and instructs the scanner unit 516 to scan a document. Upon reception of the image data from the scanner 340, the scanner unit 516 transmits the image data to the control unit 514. The control unit 514 converts the image data received from the scanner 340 into a file having a specific file format, and instructs the transmission unit 517 to transmit the file after conversion to the web application 512 based on the FTP protocol.

The external server 103 includes the external application 521 and the external service 522. The external application 521 receives a request message from the web browser 501 of the PC 101. The external application 521 analyzes the request message and then requests the external service 522 to provide the service. The external service 522 provides a file management service.

Specifically, the external service 522 uploads and downloads files, and perform file management in response to a request from the external application 521. The external application 521 generates HTML data according to a result of processing by the external service 522 and then transmits to the web browser 501 the generated HTML data as a response message.

The external service 522 provides the above-mentioned file management service also to the web application 512 of the MFP 102 based on the HTTP protocol. In this case, the external service 522 does not transmit to the web application 512 such screen information (HTML data) as the one transmitted from the external application 521 to the web browser 501. Instead, the external service 522 transmits to the web application 512 service information described in the XML format, which is file information managed by the external server 103.

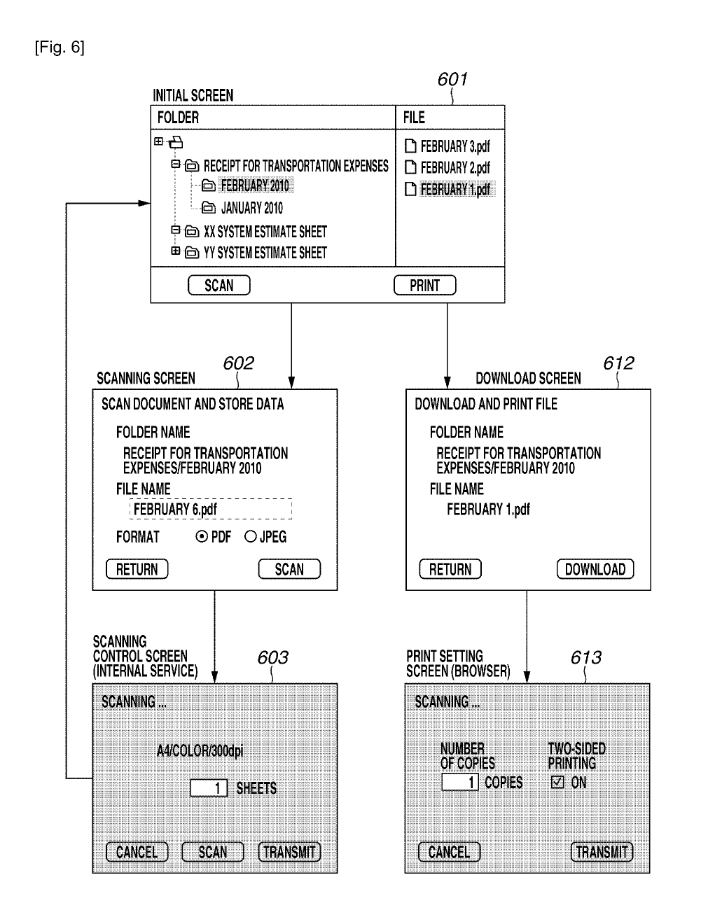

FIG. 6 illustrates an exemplary screen transition occurring in processing performed by the image processing system. All of operation screens illustrated in FIG. 6 are displayed on the operation unit 320 of the MFP 102. The web browser 511 configures an initial screen 601, a scanning screen 602, and a download screen 612 by processing the HTML data and Java (registered trademark) Script data generated by the web application 512 and then displays them on the operation unit 320. The internal service 513 generates a scanning control screen 603 and displays it on the operation unit 320. The web browser 511 generates a print setting screen 613 and displays it on the operation unit 320.

When the web browser 511 does not conform to Java (registered trademark) Script at all, the web application 512 generates the above-mentioned operation screens without using Java (registered trademark) Script and then provides the web browser 511 with them.

The initial screen 601 displays file information managed by the external service 522. The initial screen 601 displays a folder list, a file list, a SCAN button, and a PRINT button. The service information received from the external service 522 includes information about folders and files managed by the external server 103 but does not include information about the SCAN button nor PRINT button. Based on the received service information, the web application 512 generates screen information having not only the folder list and file list but also the SCAN button and PRINT button which are all arranged in the same screen.

When a specific folder is selected from the folder list, the web browser 511 displays in the file list the file information stored in the selected folder. When the SCAN button is pressed with a folder selected, the web browser 511 displays the scanning screen 602. When the PRINT button is pressed with a file selected, the web browser 511 displays the download screen 612. Java (registered trademark) Script dynamically updates the HTML data to change these screens.

The scanning screen 602 is used to scan a document, convert generated image data into a file, and upload the file to the external service 522. The scanning screen 602 includes FOLDER NAME and FILE NAME edit boxes and FORMAT and SCAN buttons. The FOLDER NAME edit box displays the name of the folder selected in the initial screen 601. The name of a file generated through document scanning is input in the FILE NAME edit box. The FORMAT button is used to select a format of a file to be generated through document scanning.

The scanning control screen 603 is used to perform continuous document scanning The scanning control screen 603 includes a SCAN button and a TRANSMIT button. The SCAN button is used to scan the following document. The TRANSMIT button is used to complete document scanning and upload the generated file to the external service 522.

The download screen 612 is used to download a file managed by the external service 522. The download screen 612 includes FOLDER NAME and FILE NAME edit boxes and a DOWNLOAD button. The FOLDER NAME edit box displays the name of a folder selected in the initial screen 601. The FILE NAME edit box displays the name of a file selected in the initial screen 601. The DOWNLOAD button is used to download from the external service 522 the file specified in the FOLDER NAME and FILE NAME edit boxes. Although the download screen 612 is displayed in FIG. 6, the print setting screen 613 may be displayed directly from the initial screen 601.

The print setting screen 613 is used to print the file downloaded from the external service 522. The print setting screen 613 includes a NUMBER OF COPIES edit box, a TWO-SIDED PRINTING check box, and a PRINT button. The number of copies to be printed is input in the NUMBER OF COPIES edit box. The TWO-SIDED PRINTING check box is used to set whether two-sided printing is made. The PRINT button is used to print the downloaded file according to a specified print setting.

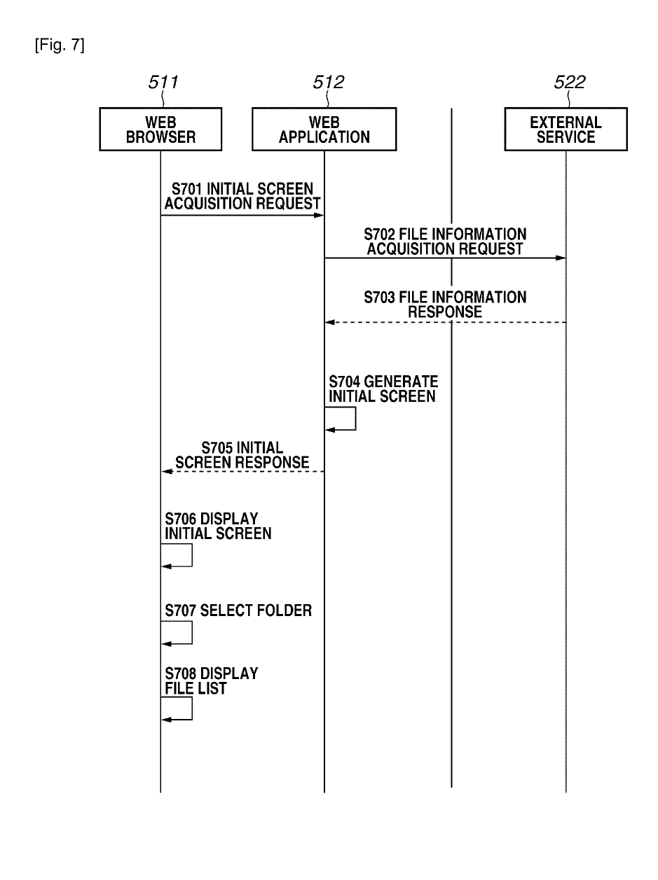

FIG. 7 is a sequence diagram illustrating processing for displaying a file list by the image processing system. In step S701, the web browser 511 transmits to the web application 512 a message requesting acquisition of the initial screen 601. In step S702, the web application 512 requests the external service 522 to acquire file information.

In step S703, the external service 522 transmits to the web application 512 a response message for returning the requested file information. The file information includes names of folders and files as well as relevant hierarchy information managed by the external service 522.

In step S704, the web application 512 generates HTML data and Java (registered trademark) Script data for displaying the initial screen 601, the scanning screen 602, and the download screen 612. In step S705, the web application 512 transmits to the web browser 511, as a response message, the HTML data and Java (registered trademark) Script data generated in step S704.

In step S706, the web browser 511 analyzes the HTML data and Java (registered trademark) Script data included in the response message to generate the initial screen 601 and then displays it on the operation unit 320. In step S707, the web browser 511 sets a folder selected in the folder list to the selection state. In step S708, the web browser 511 displays in the file list the file information included in the selected folder.

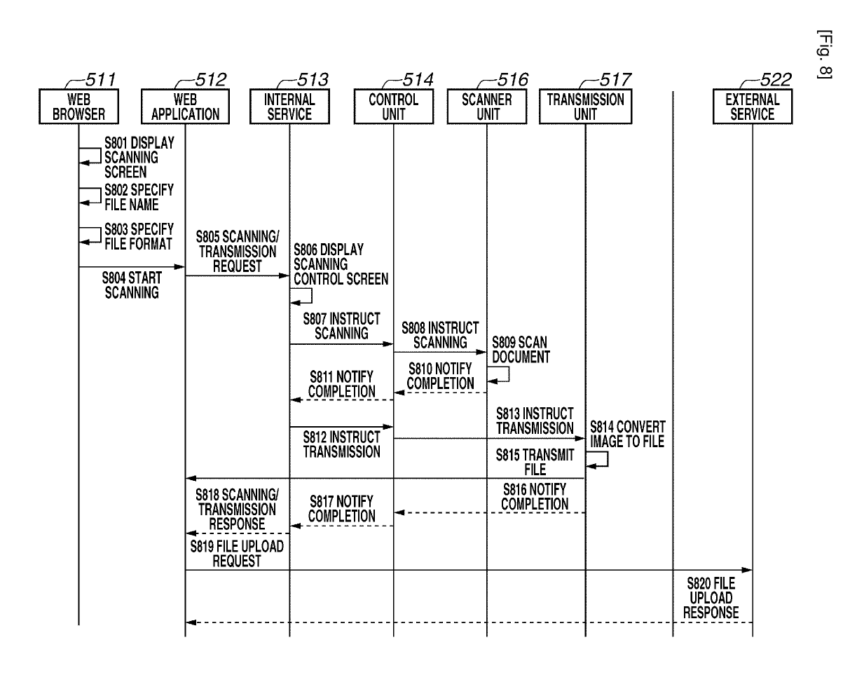

FIG. 8 is a sequence diagram illustrating scanning processing performed by the image processing system. When the SCAN button is pressed in the initial screen 601, the image processing system starts the sequence in FIG. 8. In step S801, the web browser 511 displays the scanning screen 602 by processing the Java (registered trademark) Script data to dynamically update the HTML data.

When the SCAN button is pressed in the scanning screen 602, in step S802, the web browser 511 specifies a file name input in the scanning screen 602 as the name of a file to be generated through document scanning. In step S803, the web browser 511 specifies a format selected in the scanning screen 602 as the format of the file to be generated through document scanning.

In step S804, the web browser 511 transmits to the web application 512 a message requesting the start of document scanning. In step S805, the web application 512 analyzes the request message received from the web browser 511 and then transmits to the internal service 513 a request message for requesting scanning/transmission processing.

In step S806, the internal service 513 displays the scanning control screen 603 on the operation unit 320. The scanning control screen 603 is displayed when the internal service 513 receives from the web application 512 a message requesting scanning/transmission processing.

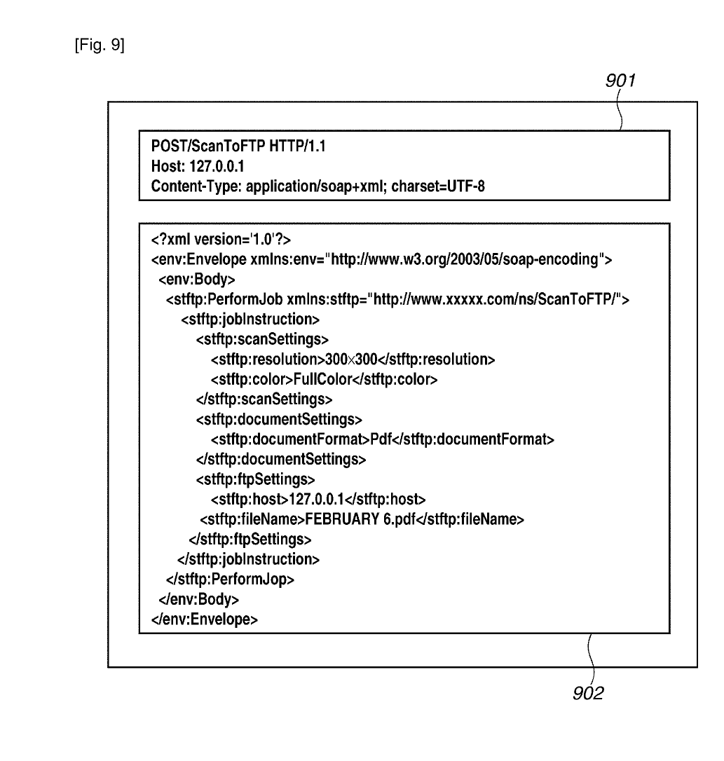

FIG. 9 illustrates an exemplary request message transmitted from the web application 512 to the internal service 513. A HTTP header 901 denotes that the HTTP method is POST, the host address is 127.0.0.1 (loopback address), and the media type of the HTTP body is XML file of SOAP. The XML file of SOAP included in a HTTP body 902 instructs to scan a document, convert a scanned image into a PDF file, and transmit it to a FTP server. The scan setting specifies a 300×300 resolution and fullcolor. The document setting specifies the PDF format. The FTP setting specifies the host address 127.0.0.1 (loopback address) and a file name “February 6.pdf.”

In step S807, upon reception of the document scanning instruction from the scanning control screen 603, the internal service 513 instructs the control unit 514 to perform scanning/transmission processing. In step S808, the control unit 514 instructs the scanner unit 516 to perform scanning processing.

In step S809, the scanner unit 516 transmits a document scanning instruction to the scanner 340. In step S810, the scanner unit 516 receives image data received from the scanner 340 and then transmits it to the control unit 514. In step S811, the control unit 514 notifies the internal service 513 of the completion of scanning.

In step S812, upon reception of a transmission instruction from the scanning control screen 603, the internal service 513 instructs the control unit 514 to transmit the image data. In step S813, the control unit 514 instructs the transmission unit 517 to perform transmission processing. In step S814, the transmission unit 517 converts the image data to a file of a specified file format. In step S815, the transmission unit 517 transmits the file to the web application 512 based on the FTP protocol.

In step S816, the transmission unit 517 notifies the control unit 514 of the completion of file transmission. In step S817, the control unit 514 notifies the internal service 513 of the completion of transmission. In step S818, the internal service 513 transmits to the web application 512 a response message for notifying the completion of scanning/transmission processing.

In step S819, the web application 512 transmits to the external service 522 a message requesting file upload. In step S820, the external service 522 transmits to the web application 512 a response message for notifying the completion of file upload.

Upon reception of the response message for notifying the completion of file upload from the external service 522, the web application 512 acquires latest file information from the external service 522 and generates the initial screen 601 again. Specifically, the web application 512 performs the above-mentioned processing of steps S702 to S705 illustrated in FIG. 7.

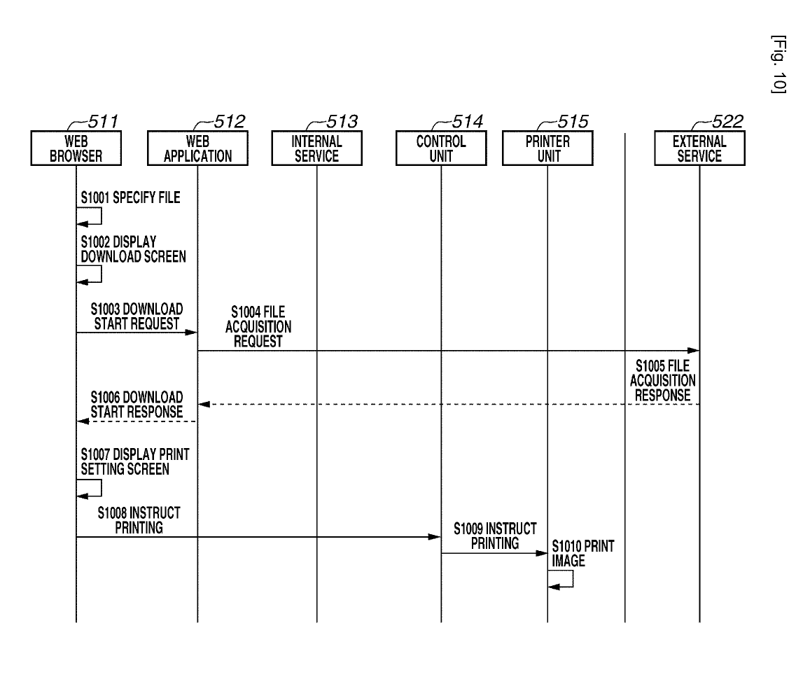

FIG. 10 is a sequence diagram illustrating print processing performed by the image processing system. The image processing system starts the sequence in FIG. 10 when a file is selected from the file list and the PRINT button is pressed in the initial screen 601.

In step S1001, the web browser 511 specifies the selected file as a file to be subjected to printing. In step S1002, the web browser 511 displays the download screen 612.

When the DOWNLOAD button in the download screen 612 is pressed, in step S1003, the web browser 511 generates a request message including a folder name and file name and then transmits it to the web application 512.

In step S1004, the web application 512 analyzes the request message received from the web browser 511 and then transmits to the external service 522 a message requesting file download.

In step S1005, the external service 522 transmits to the web application 512 a response message for returning the requested file. In step S1006, the web application 512 generates a response message based on the file received from the external service 522 and then transmits it to the web browser 511.

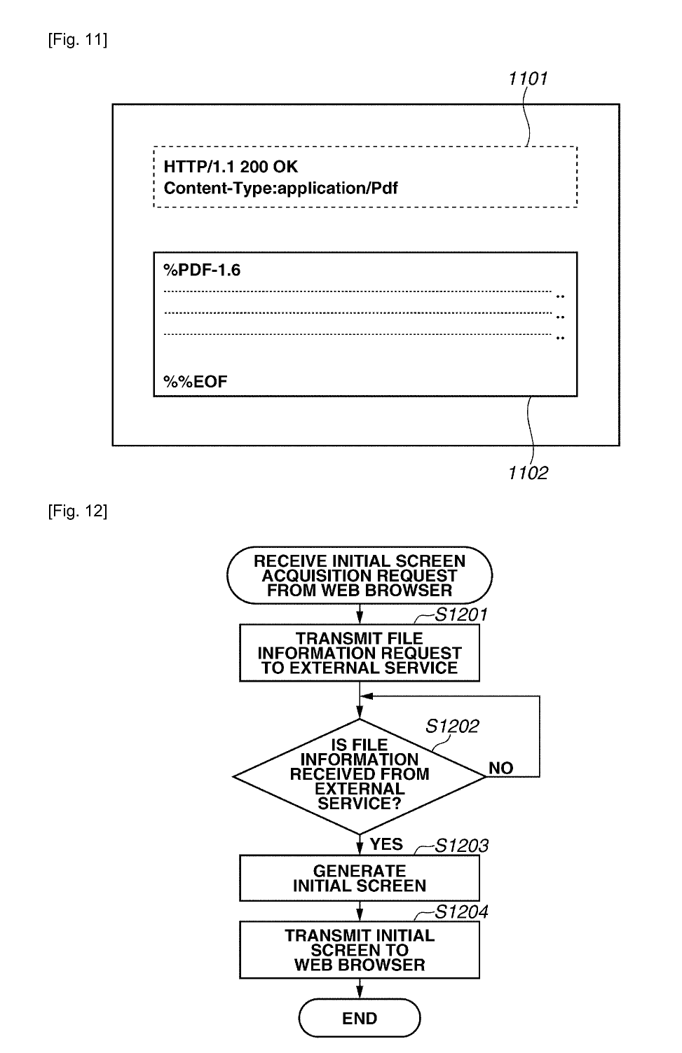

FIG. 11 is an exemplary response message transmitted from the web application 512 to the web browser 511. A HTTP header 1101 denotes that the request succeeded and that the media type of the HTTP body is a PDF file. A HTTP body 1102 denotes binary data of the PDF file.

In step S1007, when the web browser 511 determines that the response from the web application 512 is a PDF file, it displays the print setting screen 613. In step S1008, when the PRINT button in the print setting screen 613 is pressed, the web browser 511 instructs the control unit 514 to print the PDF file based on the NUMBER OF COPIES edit box and TWO-SIDED PRINTING check box set in the print setting screen 613.

In step S1009, the control unit 514 generates a print job for printing the PDF file and then transmits it to the printer unit 515. In step S1010, the printer unit 515 processes the print job, generates relevant image data, and transmits it to the printer 330.

FIG. 12 is a flow chart illustrating processing performed by the web application 512 upon reception of an initial screen acquisition request from the web browser 511. Each operation in the flow chart in FIG. 12 is implemented when the CPU 311 of the MFP 102 executes a relevant control program. Processing in FIG. 12 corresponds to the above-mentioned processing (steps S702, S704, and S705) by the web application 512 illustrated in FIG. 7.

The web application 512 starts the flow chart illustrated in FIG. 12 upon reception of a request message (from the web browser 511) requesting initial screen acquisition. In step S1201, the web application 512 transmits to the external service 522 a message requesting file information.

In step S1202, the web application 512 receives the file information from the external service 522 and the processing proceeds to step S1203. In step S1203, the web application 512 generates HTML data and Java (registered trademark) Script data for configuring the initial screen 601 from the file information received from the external service 522.

In step S1204, the web application 512 transmits the generated HTML data and Java (registered trademark) Script data, as a response message, to the web browser 511.

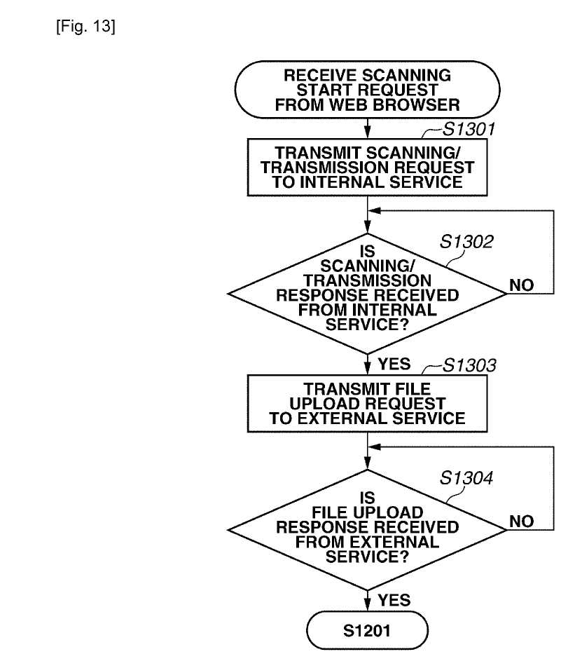

FIG. 13 is a flow chart illustrating processing performed by the web application 512 upon reception of a scanning start request from the web browser 511. Each operation in the flow chart in FIG. 13 is implemented when the CPU 311 of the MFP 102 executes a relevant control program. Processing in FIG. 13 corresponds to the above-mentioned processing (steps S805 and S819) by the web application 512 illustrated in FIG. 8.

The web application 512 starts the flow chart illustrated in FIG. 13 upon reception of a request message (from the web browser 511) for requesting the start of document scanning. In step S1301, the web application 512 analyzes the request message received from the web browser 511 and then transmits to the internal service 513 a request message for requesting scanning/transmission processing.

In step S1302, the web application 512 receives a response message for scanning/transmission processing from the internal service 513 and the processing proceeds to step S1303. In step S1303, the web application 512 transmits to the external service 522 a message requesting file upload.

In step S1304, the web application 512 receives from the external service 522 a response message notifying the completion of file upload and the processing proceeds to step S1201 in FIG. 12. Processing from step S1201 on is similar to the flow chart in FIG. 12.

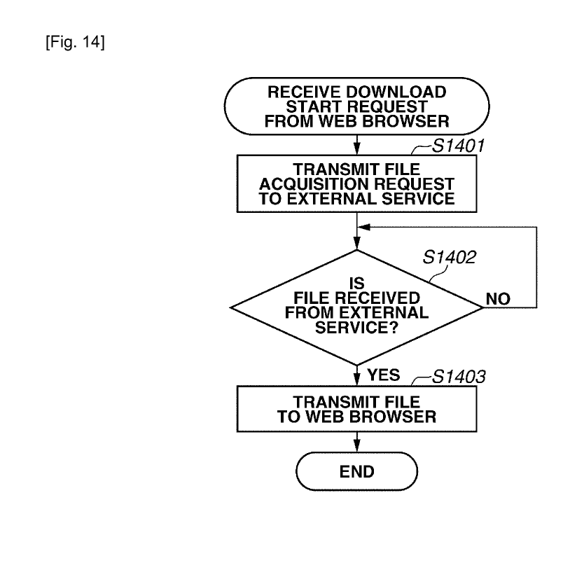

FIG. 14 is a flow chart illustrating processing performed by the web application 512 upon reception of a download start request from the web browser 511. Each operation in the flow chart in FIG. 14 is implemented when the CPU 311 of the MFP 102 executes a relevant control program. Processing in FIG. 14 corresponds to the above-mentioned processing (steps S1004 and S1006) by the web application 512 illustrated in FIG. 10.

The web application 512 starts the flow chart illustrated in FIG. 14 upon reception of a download start request from the web browser 511. In step S1401, the web application 512 analyzes the request message received from the web browser 511 and then transmits to the external service 522 a message requesting file download.

In step S1402, the web application 512 receives the requested file from the external service 522 and the processing proceeds to step S1403. In step S1403, the web application 512 generates a response message based on the received file and then transmits it to the web browser 511. Then, the image processing system performs steps S1007 to S1010 in FIG. 10 to print the image data.

With the above-mentioned configuration, the web application 512 of the MFP 102 receives service information from the external server 103. Then, using the web server function, the web application 512 generates screen information for displaying an operation screen on the web browser 511 based on the received service information.

Further, in response to a user instruction input from an operation screen displayed on the web browser 511, the web application 512 transmits and receives image data to/from the external server 103.

Specifically, even if the web browser 511 cannot analyze the HTML data provided by the external application 521 of the external server 103, the file management service provided by the external server 103 can be used from the MFP 102. Although the present exemplary embodiment has specifically been described based on a case where the external server 103 provides the file management service, the type of service provided is not limited thereto. The external server 103 can provide any type of service.

### OTHER EMBODIMENTS

Aspects of the present invention can also be realized by a computer of a system or apparatus (or devices such as a CPU or MPU) that reads out and executes a program recorded on a memory device to perform the functions of the above-described embodiments, and by a method, the steps of which are performed by a computer of a system or apparatus by, for example, reading out and executing a program recorded on a memory device to perform the functions of the above-described embodiments. For this purpose, the program is provided to the computer for example via a network or from a recording medium of various types serving as the memory device (e.g., computer-readable medium). In such a case, the system or apparatus, and the recording medium where the program is stored, are included as being within the scope of the present invention.

While the present invention has been described with reference to exemplary embodiments, it is to be understood that the invention is not limited to the disclosed exemplary embodiments. The scope of the following claims is to be accorded the broadest interpretation so as to encompass all modifications, equivalent structures, and functions.

This application claims priority from Japanese Patent Application No. 2010-041652 filed Feb. 26, 2010, which is hereby incorporated by reference herein in its entirety.

1. An image processing apparatus having a web browser and configured to use an external service provided by at least one external server, the image processing apparatus comprising:
a reception unit configured to receive service information transmitted by the at least one external server;
a web server unit configured to generate screen information for displaying an operation screen on the web browser based on the service information received by the reception unit;
a display control unit configured to display the operation screen on the web browser based on the screen information generated by the web server unit; and
a communication control unit configured to transmit and acquire image data to/from the at least one external server in response to a user instruction input via the operation screen displayed on the web browser.

2. The image processing apparatus according to claim 1, further comprising:
a printing unit configured to print the image data acquired from the at least one external server by the communication control unit.

3. The image processing apparatus according to claim 2, wherein the communication control unit acquires image data from the at least one external server in response to a user instruction, and wherein, after the communication control unit acquires image data, the printing unit prints the acquired image data in response to another user instruction.

4. The image processing apparatus according to claim 1, further comprising:
a scanning unit configured to scan a document with an image and generate image data based on the image, wherein the communication control unit transmits the image data generated by the scanning unit to the at least one external server.

5. The image processing apparatus according to claim 1, wherein the external service provided by the at least one external server is a file management service, and wherein the service information received by the reception unit includes information about files managed by the at least one external server.

6. The image processing apparatus according to claim 5, wherein the operation screen includes a list of files managed by the at least one external server, a first button for instructing to print a file contained in the list, and/or a second button for instructing to scan a document.

7. An image processing system, comprising:
at least one external server providing a file management service and including a storage unit configured to store a file and a transmission unit configured to transmit service information indicating the file stored by the storage unit; and
an image processing apparatus having a web browser and configured to use the file management service provided by the at least one external server, wherein the image processing apparatus includes:
a reception unit configured to receive the service information transmitted by the at least one external server,
a web server unit configured to generate screen information for displaying an operation screen on the web browser based on the service information received by the reception unit,
a display control unit configured to display the operation screen on the web browser based on the screen information generated by the web server unit, and
a communication control unit configured to transmit and acquire image data to/from the at least one external server in response to a user instruction input via the operation screen displayed on the web browser.

8. A method for controlling an image processing apparatus having a web browser and configured to use an external service provided by at least one external server, the method comprising:
receiving service information transmitted by the at least one external server;
generating screen information for displaying an operation screen on the web browser based on the received service information;
displaying the operation screen on the web browser based on the generated screen information; and
transmitting and acquiring image data to/from the at least one external server in response to a user instruction input via the operation screen displayed on the web browser.

9. A method for controlling an image processing system that includes at least one external server providing a file management service and an image processing apparatus having a web browser and configured to use the file management service provided by the at least one external server, the server performs method comprising:
storing a file in the at least one external server;
transmitting service information indicating the file stored in the at least one external server; and
receiving, in the image processing apparatus, service information transmitted by the at least one external server;
generating, in the image processing apparatus, screen information for displaying an operation screen on the web browser based on the received service information;
displaying, in the image processing apparatus, the operation screen on the web browser based on the generated screen information; and
transmitting, in the image processing apparatus, and acquiring, in the image processing apparatus, image data to/from the at least one external server in response to a user instruction input via the operation screen displayed on the web browser.

10. A non-transitory computer readable storage medium storing a program instructing a computer to perform a method according to claim 8.

11. A non-transitory computer readable storage medium storing a program instructing a computer to perform a method according to claim 9.
